(19) United States
(12) Patent Application Publication
(10) Pub. No.: US 2003/0146602 A1
(43) Pub. Date: Aug. 7, 2003

(54) Combination unit of a golf cart and a golf bag

(75) Inventor: Chin-Min Lu, Taipei (TW)

Correspondence Address: TROXELL LAW OFFICE PLLC, SUITE 1404, 5205 LEESBURG PIKE, FALLS CHURCH, VA, 22041, US

(73) Assignee: Hi-Mark International Design Inc.

(21) Appl. No.: 10/066,586

(22) Filed: Feb. 6, 2002

(51) Int. Cl. B62B 1/20

(52) U.S. Cl. 280/655; 280/652

(57) ABSTRACT

A combination unit of a golf cart with a golf bag, wherein: the golf bag is provided fixedly on an inner housing thereof with a frame, the inner housing has a bottom portion which has on the lateral sides thereof two receiving spaces, the inner housing has a groove on the abdomen thereof; the golf cart has a central receiving seat to carry struts for the wheels and a stretchable and contractible hand pull-bar; the central receiving seat is embedded in the groove and has an upper and a lower positioning hole, so that the hand pull-bar can be positioned in the upper or the lower positioning hole in its stretching and contracting stroke. The wheels are provided on the bottom end of the golf cart and are collapsible for storing respectively in the two receiving spaces of the bottom portion; the diameters of the wheels are larger than the heights of the receiving spaces, the whole structure thereby can be towed by rolling of the wheels both in collapsing and stretching states, thereby is fast for operation and convenient for carrying and storing.

### BACKGROUND OF THE INVENTION

1. Field of the Invention

The present invention relates to a combination unit of a golf cart with a golf bag, and especially to a combination unit having a golf bag and a golf cart structure, it has the effects of ability of being towed by rolling both in collapsing and stretching states, simplicity for operation and convenience for carrying etc., it suits the structures such as for combining a golf cart with a golf bag or for combining the like.

2. Description of the Prior Art

Since the golf game was widely promoted, the modes of combination of a golf cart with a golf bag have been highly thought of by users and manufacturers, and various combinations of golf carts with golf bags have been developed accordingly.

A golf cart is a specific appliance for carrying a golf bag, in striking golf balls in a golf course, generally golf carts are used to save carrying of golf bags on the backs of people and to alleviate loadings of people, the golf bags are placed on the golf carts to allow players to tow the golf carts during walking. However, the golf bags must be installed on the golf carts before using, and must be detached from the golf carts after using; if they are to be carried by a car, the golf bags and the golf carts must be carried in a mutual separate mode. These are very cumbersome, and they occupy too much space when in storage; thereby, they have the defects of inconvenience of using and requiring larger space for storage.

### SUMMARY OF THE INVENTION

The main object of the present invention is to provide a combination unit of a golf cart with a golf bag, with the combination unit having the golf bag and the golf cart structure, the whole volume of the golf cart and the golf bag can be largely reduced; the present invention is convenient for carrying and storing, and thereby practicality as well as convenience thereof are increased.

Another object of the present invention is to provide a combination unit of a golf cart with a golf bag, by the designing that the diameters of wheels of the golf cart are larger than the heights of the spaces respectively at both sides at the bottom of the golf cart, the whole structure can be towed by rolling of the wheels both in collapsing and stretching states, convenience of use can thus be increased.

To get the above stated objects, the present invention is a combination unit of a golf bag, a golf cart structure and two wheels. The golf bag has an inner housing with a frame thereon, the bottom portion of the inner housing has on the two lateral sides thereof two receiving spaces, and the inner housing is formed at the abdomen thereof a groove. The golf cart structure has a central receiving seat to carry the struts of the wheels and a stretchable and contractible hand pull-bar. The central receiving seat is embedded and combined in the groove of the inner housing. The stretchable and contractible hand pull-bar is provided axially in the central receiving seat, and in the inner housing of the golf bag. The central receiving seat is provided with an upper and a lower positioning hole, in order that the stretchable and contractible hand pull-bar is positioned in the upper or the lower positioning hole in its stretching and contracting stroke. The golf cart structure has on the bottom end thereof the two wheels able to be collapsed for placing in the two receiving spaces at the two lateral sides of the bottom portion of the inner housing. The diameters of the wheels are larger than the heights of the spaces respectively, the whole structure can thereby be towed by rolling of the wheels both in collapsing and stretching states; the present invention thereby is convenient and fast for operation as well as convenient for carrying and storing, and thereby practicality as well as convenience thereof are increased.

The present invention will be apparent in its characteristics and features after reading the detailed description of the preferred embodiment thereof in reference to the accompanying drawings.

### BRIEF DESCRIPTION OF THE DRAWINGS

FIG. 1 is a perspective view of an embodiment of the present invention;

FIG. 2a is a bottom view of the embodiment of the present invention, wherein, the hand pull-bar is contracted;

FIG. 2b is a sectional side view of the embodiment of the present invention, wherein, the hand pull-bar is contracted too; wherein, the hand pull-bar is pulled to stretch out;

FIG. 3a is a bottom view of the embodiment of the present invention, wherein, the hand pull-bar is being pulled to stretch out;

FIG. 3b is a sectional side view of the embodiment of the present invention, wherein, the hand pull-bar is being pulled to stretch out too;

FIG. 4a is a bottom view of the embodiment of the present invention, wherein, the hand pull-bar has been completely pulled out;

FIG. 4b is a sectional side view of the embodiment of the present invention, wherein, the hand pull-bar has been completely pulled out too;

FIG. 5 is a sectional schematic view showing the hand pull-bar of the embodiment of the present invention has been pulled out of its position;

FIG. 6 is a schematic perspective view showing the hand pull-bar of the embodiment of the present invention has been completely contracted in use.

### DETAILED DESCRIPTION OF THE PREFERRED EMBODIMENT

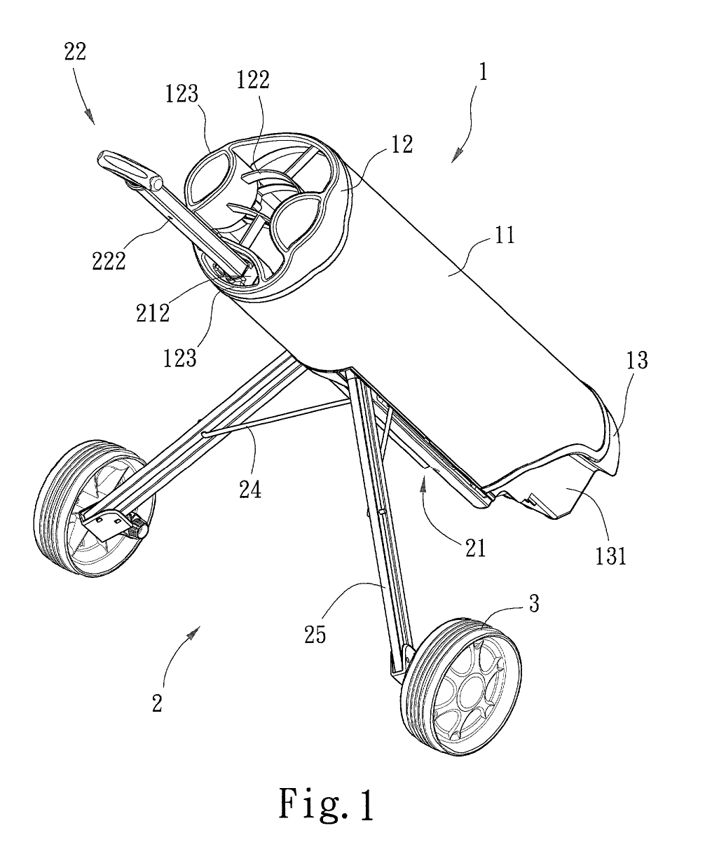

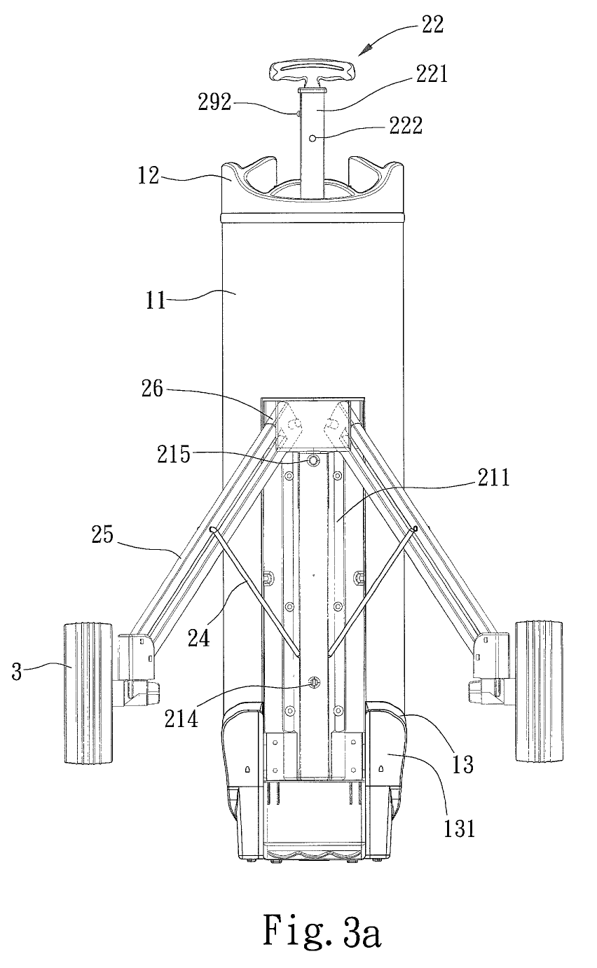

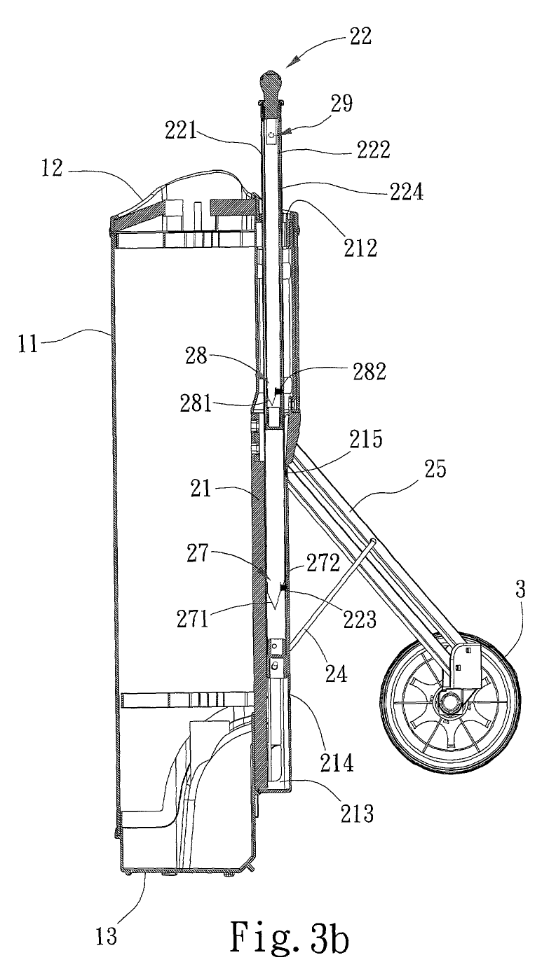

Referring to FIGS. 1-5b, the present invention is a combination unit of a golf cart with a golf bag, and is comprised of a golf bag 1, a golf cart structure 2 and two wheels 3.

The golf bag 1 is provided fixedly on an inner housing 11 thereof with a frame 12, the inner housing 11 has a bottom portion 13, the frame 12 is provided with a plurality of mutually spaced partition plates 122 and three circle frames 123. The outer edge of the bottom portion 13 of the inner housing 11 is arciform, and the bottom portion 13 is provided on the two lateral sides thereof with two receiving spaces 131 to receive the two wheels 3. The inner housing 11 is provided on the bottom abdomen thereof with a groove 111.

The golf cart structure 2 has a central receiving seat 21 to carry the struts 25 for the wheels 3 and a stretchable and contractible hand pull-bar 22. The central receiving seat 21 is embedded and combined in the groove 111 of the inner housing 11; the stretchable and contractible hand pull-bar 22 is provided axially in the central receiving seat 21, and in the inner housing 11 of the golf bag. The central receiving seat 21 is provided with a receiving housing 213, an upper positioning hole 215 and a lower positioning hole 214 are provided on the outer wall surface of the central receiving seat 21 in the scope of the length of the receiving housing 213. Two openings 211 are formed on the two lateral sides of the receiving housing 213. The stretchable and contractible hand pull-bar 22 is movably connected with the receiving housing 213; the stretchable and contractible hand pull-bar 22 includes an inner sleeve 224 and an outer sleeve 221 which is provided around and movably connected with the inner sleeve 224. The outer sleeve 221 is provided on the upper wall thereof with an engaging hole 222, and on the lower wall thereof with an engaging hole 223; and is provided on the inner wall thereof with a first locking member 27. The first locking member 27 engages with one end of a folded spring leaf 271, the other end of the folded spring leaf 271 is fixedly provided with a snap catch 272 which is engaged in the engaging hole 223 on the lower wall of the outer sleeve 221. The hand pull-bar 22 extends through a front one of the three circle frames 123 on the frame 12, and a sliding auxiliary portion 212 is provided on the upper area of the central receiving seat 21 in the front circle frame 123 on the frame 12 for extending of the hand pull-bar 22 therethrough, hence the hand pull-bar 22 can be stable in sliding. The inner sleeve 224 has an engaging hole 225 on the lower portion thereof, and is provided on the inner wall thereof with a second locking member 28. The second locking member 28 on the inner wall of the inner sleeve 224 engages with one end of a folded spring leaf 281; the other end of the folded spring leaf 281 is fixedly provided with a snap catch 282 which is provided in the engaging hole 225 on the lower wall of the inner sleeve 224. A third locking member 29 is provided on the inner wall of the inner sleeve 224 and engages with one end of a folded spring leaf 291, the other end of the folded spring leaf 291 is fixedly provided with a snap catch 292 which is provided in engaging holes respectively provided on the walls of the outer sleeve 221 and the inner sleeve 224.

The central receiving seat 21 is provided with two joints 26 formed by two sets of transverse sheets to movably connect with two struts 25. The struts 25 have on the bottom ends thereof two wheels 3, and are movably connected each with a link 24 on the inner side near the middle thereof, the other ends of the links 24 are movably connected to the bottom wall of the outer sleeve 221. The diameters of the wheels 3 are larger than the heights of the receiving spaces 131; the whole structure in collapsing can thereby be in the shape of a golf bag apparently. The wheels 3 protrude out of the receiving spaces 131 at the two lateral sides of the bottom portion 13 of the inner housing 11, the golf bag 1 is moved by means of the wheels 3. When the golf cart structure 2 is stretched out, the wheels 3 and the bottom 13 of the golf bag 1 form on the ground a triangle, the hand pull-bar 22 can be pulled to stretch upwardly, so that the golf bag 1 is mounted on the golf cart 2 and can be towed in the golf course.

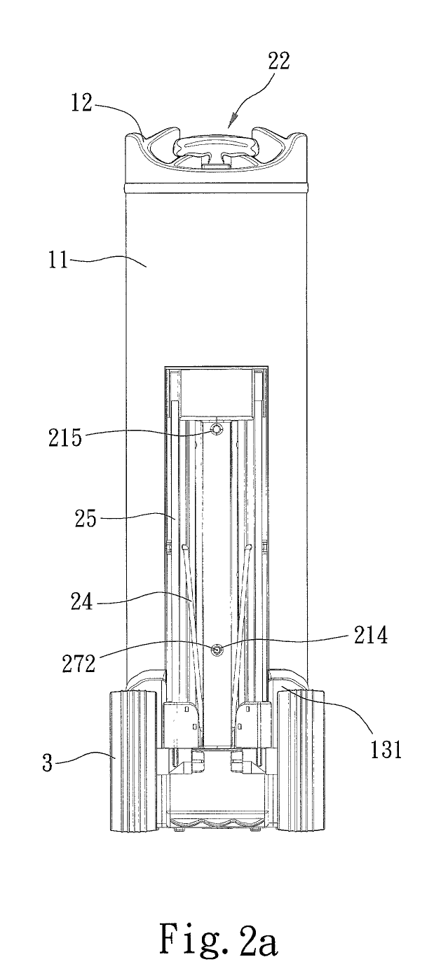

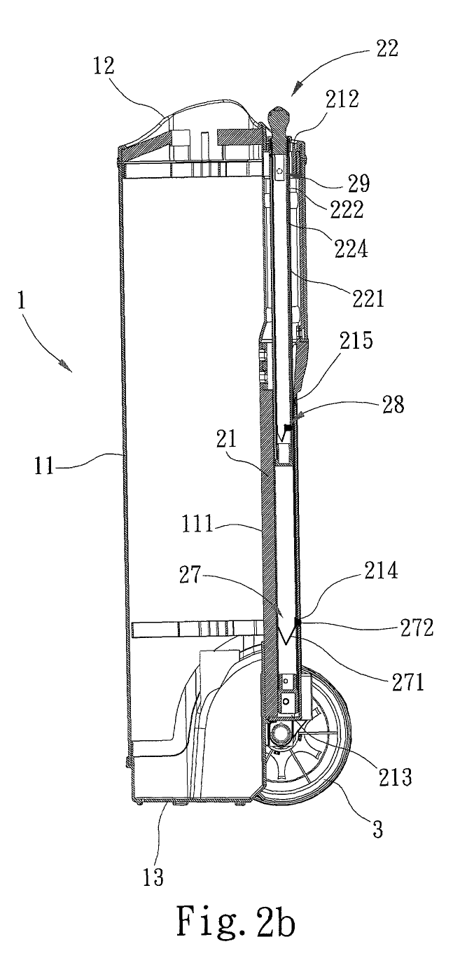

With the above stated elements constructing the combination unit of a golf cart 2 with a golf bag 1, referring to FIGS. 1-6, the present invention is characterized by that, the golf bag 1, the golf cart structure 2 and the two wheels 3 are connected mutually; and by connecting the central receiving seat 21 of the golf cart structure 2 with the two struts 25 and the stretchable and contractible hand pull-bar 22, when in collapsing (referring to FIGS. 2a and 2b), the first locking member 27 provided on the inner wall of the outer sleeve 221 will make the snap catch 272 engaged in the engaging hole 223 on the lower wall of the outer sleeve 221 and in the lower positioning hole 214 of the central receiving seat 21 by the action of the spring leaf 271. Thereby, the outer sleeve 221 of the stretchable and contractible hand pull-bar 22 is firmly combined with the lower positioning hole 214 of the central receiving seat 21. When the snap catch 272 is pressed down (referring to FIGS. 2a-4b), the stretchable and contractible hand pull-bar 22 is pulled out in its first stretching stage, at this moment, the second locking member 28 provided on the inner wall of the inner sleeve 224 will make the snap catch 282 engaged with the inner wall of the outer sleeve 221 by the action of the spring leaf 281. And further, the inner sleeve 224 and the outer sleeve 221 are stretched and moved upwardly together from their bottommost positioning state (there is no relative displacement between the inner sleeve 224 and the outer sleeve 221) until the snap catch 272 of the first locking member 27 slides to the upper positioning hole 215 of the central receiving seat 21, then the snap catch 272 is elastically engaged in the upper positioning hole 215 of the central receiving seat 21 and the engaging hole 223 on the lower wall of the outer sleeve 221. When the hand pull-bar 22 is pulled out, the two lateral links 24 are moved upwardly, and in turn the two struts 25 and the wheels 3 are braced up; thereby, the central receiving seat 21, the two struts 25 and the links 24 are in a stable bracing up and positioning state.

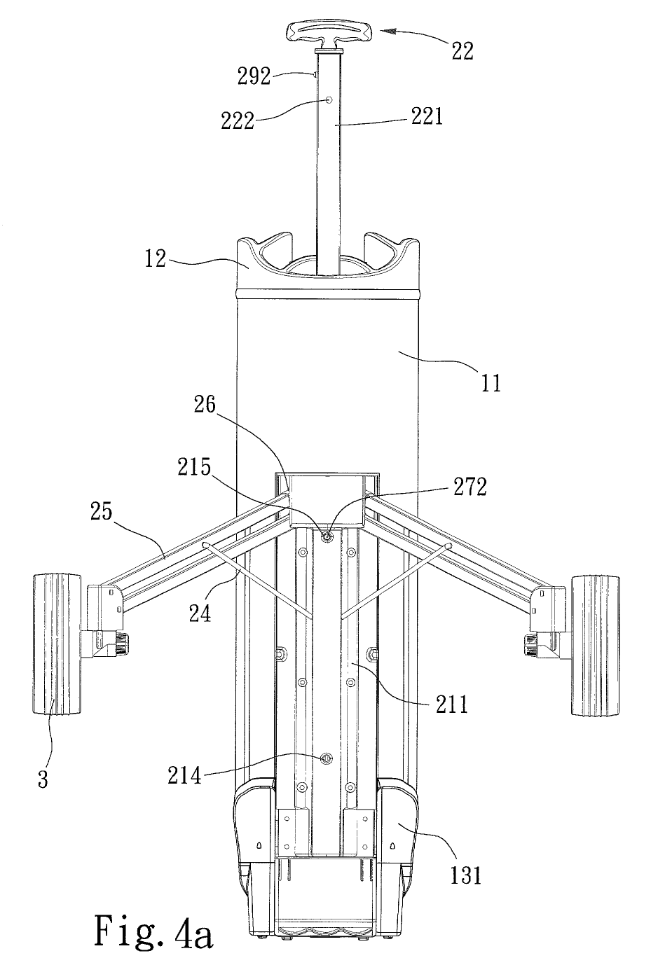

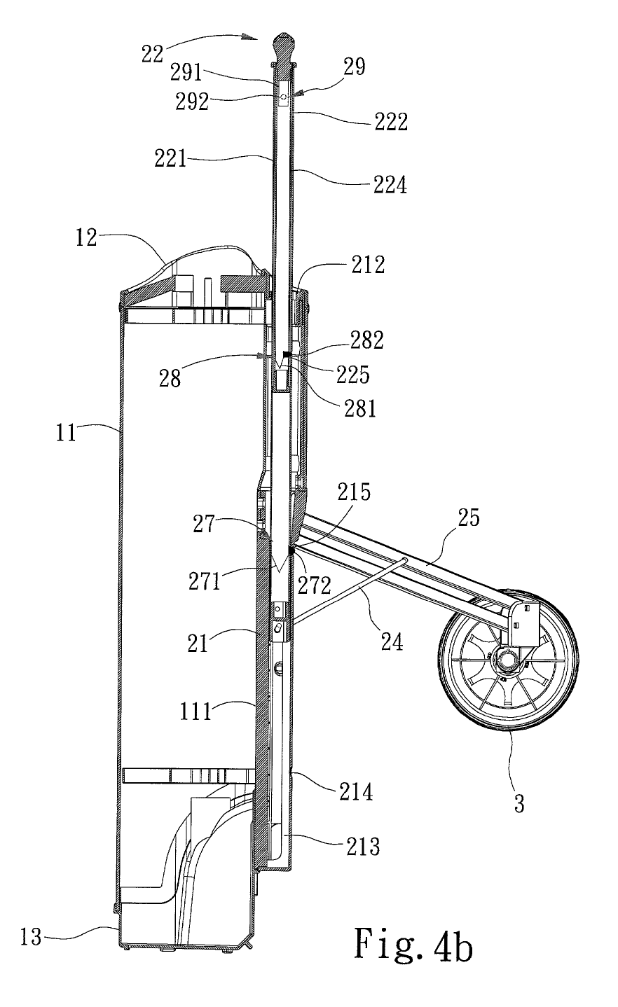

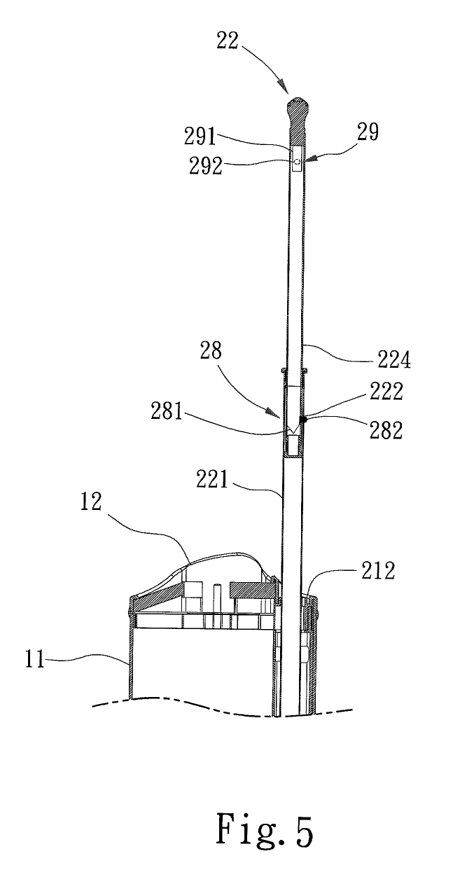

Referring to FIGS. 4a-5, the purpose of providing the third locking member 29 is to control fixing and unlocking between the inner sleeve 224 and the outer sleeve 221. When the snap catch 292 of the third locking member 29 is pressed down, the inner sleeve 224 can be pulled out as being the second stretching stage of the stretchable and contractible hand pull-bar 22 (at this time, the outer sleeve 221 is stationary and there is relative movement between the inner sleeve 224 and outer sleeve 221) until the snap catch 282 of the second locking member 28 slides to the engaging hole 222 of the outer sleeve 221, then the snap catch 282 is elastically engaged in the engaging hole 225 on the inner sleeve 224 and the engaging hole 222 of the outer sleeve 221. Thereby, the hand pull-bar 22 is stretched for use. On the contrary, the hand pull-bar 22 can be contracted by simply pressing down the snap catch 282 and the snap catch 272 to restore the state of being engaged in the lower positioning hole 214 the central receiving seat 21. And no further detailed description is needed here.

In fact, the third locking member 29 can be omitted, and when the hand pull-bar 22 is in the second stretching stage, it needs only to make the snap catch 282 of the second locking member 28 on the inner sleeve 224 engage with the inner wall of the outer sleeve 221 by the action of the spring leaf 281 to make elastic engagement between the inner sleeve 224 and the outer sleeve 221, and the inner sleeve 224 can be directly pulled out for the second stretching stage (at this time, the outer sleeve 221 is stationary) until the snap catch 282 of the second locking member 28 slides to the engaging hole 222 of the outer sleeve 221, then the snap catch 282 is elastically engaged in the engaging hole 225 on the inner sleeve 224 and the engaging hole 222 of the outer sleeve 221 by the elastic restoration of the spring leaf 281. This also results that the hand pull-bar 22 is stretched for use.

Meantime, the two links 24 on the hand pull-bar 22 move the struts 25 to make collapsing of the wheels 3 in the receiving spaces 131 on the two lateral sides of the bottom portion 13, this largely reduces the entire volume of the whole unit. The unit can be towed by rolling of the wheels 3 both in collapsing and stretching states; the present invention thereby has the effects of ability to be towed by rolling both in collapsing and stretching states, simplicity and fastness for operation and convenience for carrying, storing etc., and thereby practicality as well as convenience thereof are increased, thus the combination unit of a golf cart with a golf bag can be completed.

Referring to FIG. 1, when in use, the golf bag 1, the golf cart structure 2 and the two wheels 3 are mutually connected according to the aforesaid; then the golf cart structure 2 is stretched out, the bottom portion 13 of the golf bag 1 and the struts 25 let out the wheels 3 to form firm supporting.

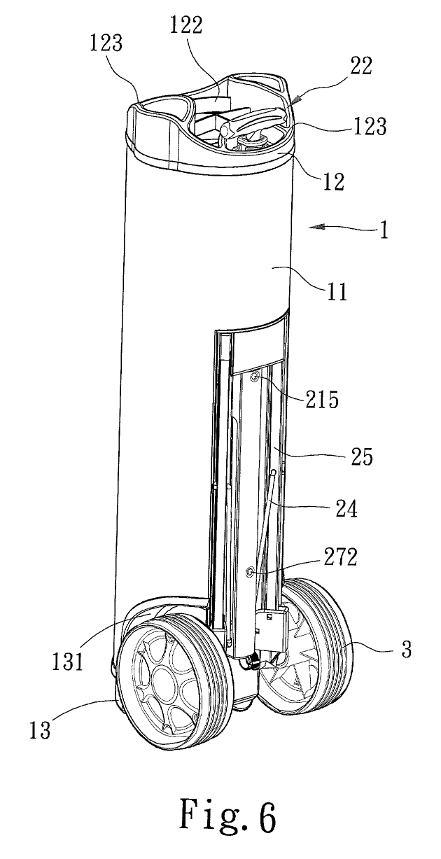

Referring to FIG. 6, when in use, the golf bag 1 and the golf cart structure 2 are collapsed, now the wheels 3 are collapsed to be stored in the spaces 131 on the two lateral sides of the bottom portion 13, and the struts 25 as well as the two links 24 are received in the meantime in the openings 211 of the central receiving seat 21 to largely reduce the volume of the whole unit to be convenient for carrying. The unit can be towed by rolling of the wheels 3 both in collapsing and stretching states even in an uneven golf course.

The description above relating to the golf bag 1 depicted are only described for the part in the inner housing 11; in practice, the inner housing 11 can be used in mating with any of various bags outside of it (not shown). It needs only that the central receiving seat 21 is arranged to have a zipper; so that after collapsing, the zipper can be pulled to close, and when in stretching out the struts 25, the zipper can be pulled to open.

The longitudinal lengths in the inner housing 11 of the golf bag 1 of the present invention from the interior portions of the two lateral circle frames 123 to the bottom portion 13 are shorter such that they can receive iron clubs or umbrellas, while the longitudinal length from the portion outside of the circle frames 123 to the bottom portion 13 in the inner housing 11 is longer to receive wooden golf clubs.

The present invention thereby has the following advantages:

1. The present invention has a golf cart combined with a golf bag, the whole volume thereof can be largely reduced; the present invention is convenient for carrying, and thereby practicality as well as convenience thereof are increased.

2. The present invention is designed that the diameters of the wheels are larger than the heights of the spaces respectively at both sides at the bottom of the golf cart, the whole structure can be towed by rolling of the wheels both in collapsing and stretching states, it is extremely convenient in use.

3. The present invention is fast in stretching and collapsing; thereby it is convenient for operation.

Accordingly, the present invention not only can get rid of the defects resided in the conventional combinations of golf bags with golf carts, the designing of the combination unit of a golf cart structure with a golf bag of the present invention can get the effects of simplicity for operation and convenience for carrying etc. by ability of being towed by rolling both in collapsing and stretching states, thereby practicality as well as convenience thereof are largely increased.

Having thus described my invention with value of practical utility, what I claim as new and desire to be secured by Letters Patent of the United States are:

What is claimed is:

1. A combination unit of a golf cart with a golf bag comprising a golf bag, a golf cart structure and two wheels, wherein:
said golf bag has an inner housing and is fixedly provided on said inner housing with a frame, said inner housing has a bottom portion, said bottom portion is provided on the two lateral sides thereof with two receiving spaces, and said inner housing is provided on the bottom abdomen thereof with a groove;
said golf cart structure is collapsible and stretchable, and has a central receiving seat to carry struts for said wheels and a stretchable and contractible hand pull-bar; said central receiving seat is embedded and combined in said groove of said inner housing; said stretchable and contractible hand pull-bar is provided axially in said central receiving seat, and in said inner housing of said golf bag; said central receiving seat is provided with an upper and a lower positioning hole, in order that said stretchable and contractible hand pull-bar is positioned in said upper or the lower positioning hole in its stretching and contracting stroke; said two wheels are provided on the bottom end of said golf cart structure and are adapted to collapsing for storing respectively in said two receiving spaces provided on said two lateral sides of said bottom portion; the diameters of said wheels are larger than the heights of said receiving spaces, the whole of said structure thereby is in the shape of a single golf bag apparently; said wheels protrude out of said receiving spaces at said two lateral sides of said bottom portion of said inner housing, said golf bag is moved by means of said wheels; when said hand pull-bar is pulled up and stretched out, said golf cart structure is stretched out by means of links, said wheels and the bottom of said golf bag form on the ground a triangle, so that said golf bag is mounted on said golf cart and is allowed to be towed in a golf course.

2. A combination unit of a golf cart with a golf bag as stated in claim 1, wherein:
said central receiving seat is provided with a receiving housing for movable connecting of said hand pull-bar therewith.

3. A combination unit of a golf cart with a golf bag as stated in claim 2, wherein:
said central receiving seat is provided on the two lateral sides of said receiving housing with two openings for receiving said struts and links.

4. A combination unit of a golf cart with a golf bag as stated in claim 1, wherein:
said hand pull-bar includes an inner sleeve and an outer sleeve provided around and movably connected with said inner sleeve, said outer sleeve is provided on the upper and the lower walls thereof respectively with an engaging hole, said outer sleeve is provided on the inner wall thereof with a first locking member for contracting and positioning of said inner sleeve and said outer sleeve to be stretched upwardly together from their bottommost positioning state in the first stretching stage of said hand pull-bar.

5. A combination unit of a golf cart with a golf bag as stated in claim 4, wherein:
said first locking member engages with one end of a first folded spring leaf on the inner wall of said outer sleeve, the other end of said first folded spring leaf is fixedly provided with a first snap catch which is engaged in said engaging hole on the lower wall of said outer sleeve.

6. A combination unit of a golf cart with a golf bag as stated in claim 4, wherein:
said inner sleeve has an engaging hole on the lower portion thereof, and is provided on the inner wall thereof with a second locking member, said second locking member on said inner wall of said inner sleeve engages with one end of a second folded spring leaf; the other end of said second folded spring leaf is fixedly provided with a second snap catch which is provided in said engaging hole on said lower wall of said inner sleeve and is engaged with said inner wall of said outer sleeve to make elastic engagement between said inner sleeve and said outer sleeve, when said inner sleeve is pulled out, said second locking member is used to effect the said second stretching stage of the hand pull-bar by means of the relative movement between said inner sleeve and said outer sleeve.

7. A combination unit of a golf cart with a golf bag as stated in claim 1, wherein:
said central receiving seat is provided with two joints formed by two sets of transverse sheets to movably connect with said two struts, said struts have on the bottom ends thereof said two wheels, and are movably connected each with one of said links on the inner side near the middle thereof, the other ends of said links are movably connected to the bottom wall of said outer sleeve in favor of stretching and collapsing of said combination unit.

8. A combination unit of a golf cart with a golf bag as stated in claim 1, wherein:
the longitudinal lengths in said inner housing from the interior portions of said circle frames to said bottom portion are shorter such that they are used to receive iron clubs or umbrellas, while the longitudinal length from the portion outside of two lateral circle frames to said bottom portion in said inner housing is longer to receive wooden golf clubs.

9. A combination unit of a golf cart with a golf bag as stated in claim 1, wherein:
a sliding auxiliary portion is provided on the upper area of said central receiving seat for extending of said hand pull-bar therethrough for stable sliding.

10. A combination unit of a golf cart with a golf bag as stated in claim 6, wherein:
a third locking member is provided on said inner wall of said inner sleeve and engages with one end of a third folded spring leaf, the other end of said third folded spring leaf is fixedly provided with a third snap catch which is provided in said engaging holes respectively provided on the upper wall of said outer sleeve and on the wall of said inner sleeve.
